(19) United States
(12) Patent Application Publication
(10) Pub. No.: US 2016/0168354 A1
(43) Pub. Date: Jun. 16, 2016

(54) FLUOROELASTOMER COMPOSITION

(71) Applicant: SOLVAY SPECIALTY POLYMERS ITALY S.P.A., Bollate (Milano) (IT)

(72) Inventors: Stefano BOSSOLO, Parabiago (IT); Giovanni COMINO, Monza (IT)

(21) Appl. No.: 14/392,211

(22) PCT Filed: Jun. 18, 2014
(86) PCT No.: PCT/EP2014/062840

§ 371 Date: Dec. 23, 2015

(30) Foreign Application Priority Data
Jun. 24, 2013 (EP) 13173449.3

(51) Int. Cl. C08K 5/14; C08K 5/01; C08K 13/02; C08K 3/22

(52) U.S. Cl. CPC C08K 5/14; C08K 3/22; C08K 5/01; C08K 13/02; C08K 2003/2296

(57) ABSTRACT

The invention pertains to a fluoroelastomer composition comprising: —at least one fluoroelastomer [fluoroelastomer (A)]; —from 0.1 to 15 weight parts, per 100 parts by weight of said fluoroelastomer (A), of meta-divinylbenzene; —from 0.1 to 10 weight parts, per 100 parts by weight of said fluoroelastomer (A), of at least one peroxide.

### CROSS-REFERENCE TO RELATED APPLICATIONS

This application claims priority to European application No. 13173449.3 filed Jun. 24, 2013, the whole content of this application being incorporated herein by reference for all purposes.

### TECHNICAL FIELD

This invention pertains to certain fluoroelastomer curable blends, to a method of using the same for fabricating shaped articles and to cured articles there from.

### BACKGROUND ART

Fluoroelastomers are a class of high-performance materials with a diverse range of applications ranging from O-rings, valve stem seals, shaft seals, gaskets and fuel hoses in automotive applications to seals and packing for oil wells, further including seals, O-rings and other parts in semi-conductors' manufacturing devices. Fluoroelastomers have indeed established themselves as premium materials in the automotive, chemical petrochemical and electronics industries thanks to their un-matched heat, chemical and permeation resistance.

It is also understood that properties of final vulcanized parts made from fluoroelastomers are greatly influenced by the curing system employed, with peroxide-based curing being considered as delivering higher performances over bis-phenol-based ionic curing.

In peroxide-based curing, a peroxide is added to the fluoroelastomer comprising, either as pendant groups in recurring units of the main chain, or as end-groups, certain cure sites able to react under radical condition, and to a polyfunctional unsaturated compound. Under the effect of heat, the peroxide generates radicals which promote reactions of the fluoroelastomer chain, activated through the cure sites, with the polyfunctional unsaturated compound for yielding a cured mass, with chemically interconnected polymer chains.

When fluoroelastomer is intended to be processed and cured by extrusion for manufacturing flexible hoses and tubings, and/or when fluoroelastomer is used for manufacturing sealing parts of turbochargers, the need of bi-functional crosslinkers is provided by final field of use, questing for improved flexibility (including increased elongation at break) which is generally not achievable using polyfunctional crosslinkers such as TAIC (having three allyl reactive groups), which generally provide for more “stiff” cured articles, having better tensile properties, but less flexibility and elongation at break.

Within this frame, fluorinated bis-olefins of general formula CH₂═CH—(CF₂)ₙ—CH═CH₂ (n=3-8) have found wide application; nevertheless, because of the high cost of these curing agents and the complex chemical steps required for their manufacture, availability of the same might become critical, especially when high volumes applications are targeted. The quest for easily accessible and low-cost curing agent suitable for delivering outstanding performances in cured fluoroelastomer compounds is thus open.

Divinyl-benzenes have been proposed in the past as crosslinking agents.

GB 1152208 (MINISTERY OT TECHNOLOGY (GB)) 14 May 1969 discloses the use of divinylbenzene as crosslinking agent in the peroxide-assisted curing of a VITON® A fluoroelastomer (i.e. a VDF-HFP copolymer) which has been previously submitted to a specific dehydrofluorination process. It is noticeable that this document broadly teaches away from the use of divinylbenzene as cross-linking agent for the fluoroelastomers as such, stating that only by means of the above mentioned dehydrofluorination process, the elastomers can be cured with such DVB, while untreated elastomers cannot be cured in a reasonable time.

U.S. Pat. No. 5,251,399 12 Oct. 1993 discloses peroxide curable compounds of fluoroelastomer and hydrocarbon rubber, which are cured by using an organic peroxide in combination with a crosslinking agent. Among suitable crosslinking agents, is mention made in column 3, line 14 of divinylbenzene. Nevertheless, such crosslinking agent is not exemplified.

U.S. Pat. No. 4,530,971 (AUSIMONT) 23 Jul. 1985 discloses certain peroxide co-vulcanizable mixtures of a fluoroelastomer (a VDF/TFE/HFP terpolymer), a diamino compound and a TFE/propylene polymer, which are cured via an organic peroxide vulcanizing agent; divinylbenzene is mentioned as possible vulcanizing co-agent in column 1, line 58, but not exemplified.

U.S. Pat. No. 5,202,372 (AUSIMONT) 13 Apr. 1993 discloses peroxide curable compositions including certain VDF telomers/cotelomers additives. Divinylbenzene is mentioned as crosslinking agent in column 4, line 23, but not exemplified.

### SUMMARY OF INVENTION

The Applicant has now found that meta-divinylbenzene is effective in the peroxide curing of fluoroelastomers and has a particularly favourable balance of availability and cost, so that target performances can be achieved through the use of this curative at competitive costs.

The invention thus pertains to a fluoroelastomer composition comprising:
at least one fluoroelastomer [fluoroelastomer (A)];
from 0.1 to 15 weight parts, per 100 parts by weight of said fluoroelastomer (A), of meta-divinylbenzene;
from 0.1 to 10 weight parts, per 100 parts by weight of said fluoroelastomer (A), of at least one peroxide.

The Applicant has surprisingly found that meta-divinylbenzene, which is available in greater quantities and lower price than its para-isomer, and which is much easier to be handled, thanks to its better stability over its para-isomer, can be efficiently used as cross-linking agent in peroxide curable compounds, as above detailed, thus providing for adequate curing rates and acceptable and sustainable mechanical and sealing properties, thus, overall, delivering an improved cost/performances balance.

For the purposes of this invention, the term “(per)fluoroelastomer” [fluoroelastomer (A)] is intended to designate a fluoropolymer resin serving as a base constituent for obtaining a true elastomer, said fluoropolymer resin comprising more than 10% wt, preferably more than 30% wt, of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer).

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Non limitative examples of suitable (per)fluorinated monomers are notably:
C₂-C₈ perfluoroolefins, such as tetrafluoroethylene (TFE), hexafluoropropene (HFP);
C₂-C₈ hydrogen-containing fluoroolefins, such as vinyl fluoride, 1,2-difluoroethylene, vinylidene fluoride (VDF), trifluoroethylene (TrFE), pentafluoropropylene, and hexafluoroisobutylene;
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins, like chlorotrifluoroethylene (CTFE);
fluoroalkylvinylethers complying with formula CF₂═CFOR_{f1} in which R_{f1} is a C₁-C₆ fluoro- or perfluoroalkyl, e.g. —CF₃, —C₂F₅, —C₃F₇;
hydrofluoroalkylvinylethers complying with formula CH₂═CFOR_{f1} in which R_{f1} is a C₁-C₆ fluoro- or perfluoroalkyl, e.g. —CF₃, —C₂F₅, —C₃F₇,
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups, like perfluoro-2-propoxy-propyl;
fluoroalkyl-methoxy-vinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
fluorodioxoles, of formula:

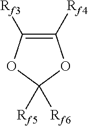

wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.

Examples of hydrogenated monomers are notably C₂-C₈ non-fluorinated olefins (Ol), in particular C₂-C₈ non-fluorinated alpha-olefins (Ol), including ethylene, propylene, 1-butene; diene monomers; styrene monomers; with alpha-olefins, as above detailed, being typically used.

Fluoroelastomers (A) are in general amorphous products or products having a low degree of crystallinity (crystalline phase less than 20% by volume) and a glass transition temperature (T_{g}) below room temperature. In most cases, the fluoroelastomer (A) has advantageously a T_{g} below 10° C., preferably below 5° C., more preferably 0° C.

The fluoroelastomer (A) is preferably selected among:

(1) VDF-based copolymers, in which VDF is copolymerized with at least one comonomer chosen from the followings classes:
(a) C₂-C₈ perfluoroolefins, such as tetrafluoroethylene (TFE), hexafluoropropylene (HFP);
(b) hydrogen-containing C₂-C₈ fluoro-olefins, such as vinyl fluoride (VF), trifluoroethylene (TrFE), perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, e.g. CF₃, C₂F₅, C₃F₇;
(e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

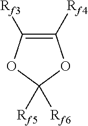

wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluoroclioxoles;
(g) (per)fluoro-methoxy-vinylethers (MOVE, hereinafter) having formula:

CFX₂═CX₂OCF₂OR″_{f}

wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂═F, H; preferably X₂ is F and R″_{f} is —CF₂CF₃ (MOVE1); —CF₂CF₂OCF₃ (MOVE2); or —CF₃ (MOVE3);
(h) C₂-C₈ non-fluorinated olefins (Ol), for example ethylene and propylene; and
(2) TFE-based copolymers, in which TFE is copolymerized with at least one comonomer selected from classes (a) (different from TFE), (c), (d), (e), (f), (g), as above detailed and the followings:
(i) perfluorovinyl ethers containing cyanide groups, such as notably those described in patents U.S. Pat. No. 4,281,092, U.S. Pat. No. 5,447,993 and U.S. Pat. No. 5,789,489.

Optionally, fluoroelastomer (A) of the present invention also comprises recurring units derived from at least one bis-olefin [bis-olefin (OF)] having general formula:

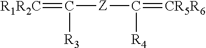

wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical, e.g. as described in EP 661304 A (AUSIMONT SPA) 5 Jul. 1995.

The bis-olefin (OF) is preferably selected from the group consisting of those complying with formulae (OF-1), (OF-2) and (OF-3):

### (OF-1)

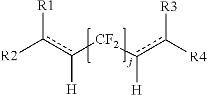

wherein j is an integer between 2 and 10, preferably between 4 and 8, and R1, R2, R3, R4, equal or different from each other, are H, F or C₁₋₅ alkyl or (per)fluoroalkyl group;

### (OF-2)

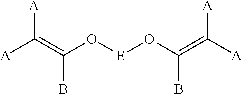

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

### (OF-3)

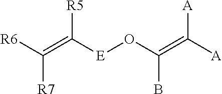

wherein E, A and B have the same meaning as above defined; R5, R6, R7, equal or different from each other, are H, F or C₁₋₅ alkyl or (per)fluoroalkyl group.

Among specific compositions of fluoroelastomers (A) suitable for the purpose of the invention, mention can be made of fluoroelastomers having the following compositions (in mol %):

(i) vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%;
(ii) vinylidene fluoride (VDF) 50-80%, perfluoroalkyl vinyl ethers (PAVE) 5-50%, tetrafluoroethylene (TFE) 0-20%, bis-olefin (OF) 0-5%;
(iii) vinylidene fluoride (VDF) 20-30%, C₂-C₈ non-fluorinated olefins (Ol) 10-30° A), hexafluoropropene (HFP) and/or perfluoroalkyl vinyl ethers (PAVE) 18-27%, tetrafluoroethylene (TFE) 10-30%, bis-olefin (OF) 0-5%;
(iv) tetrafluoroethylene (TFE) 50-80%, perfluoroalkyl vinyl ethers (PAVE) 20-50%, bis-olefin (OF) 0-5%;
(v) tetrafluoroethylene (TFE) 45-65%, C₂-C₈ non-fluorinated olefins (Ol) 20-55%, vinylidene fluoride 0-30%, bis-olefin (OF) 0-5%;
(vi) tetrafluoroethylene (TFE) 32-60% mol %, C₂-C₈ non-fluorinated olefins (Ol) 10-40%, perfluoroalkyl vinyl ethers (PAVE) 20-40%, fluorovinyl ethers (MOVE) 0-30%, bis-olefin (OF) 0-5%;
(vii) tetrafluoroethylene (TFE) 33-75%, perfluoroalkyl vinyl ethers (PAVE) 15-45%, vinylidene fluoride (VDF) 5-30%, hexafluoropropene HFP 0-30%, bis-olefin (OF) 0-5%;
(viii) vinylidene fluoride (VDF) 35-85%, fluorovinyl ethers (MOVE) 5-40%, perfluoroalkyl vinyl ethers (PAVE) 0-30%, tetrafluoroethylene (TFE) 0-40%, hexafluoropropene (HFP) 0-30%, bis-olefin (OF) 0-5%;
(ix) tetrafluoroethylene (TFE) 20-70%, fluorovinyl ethers (MOVE) 30-80%, perfluoroalkyl vinyl ethers (PAVE) 0-50%, bis-olefin (OF) 0-5%.

The fluoroelastomer (A) can be prepared by any known method, such as emulsion or micro-emulsion polymerization, suspension or micro-suspension polymerization, bulk polymerization and solution polymerization.

According to certain preferred embodiments of the invention, the fluoroelastomer (A) comprises cure sites; the selection of cure sites is not particularly critical, provided that they ensure adequate reactive in curing.

The fluoroelastomer (A) can comprise said cure sites either as pendant groups bonded to certain recurring units or as end groups of the polymer chain.

Among cure-site containing recurring units, mention can be notably made of:

### (CSM-1) Iodine or Bromine Containing Monomers of Formula:

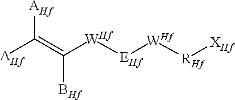

wherein each of A_{Hf}, equal to or different from each other and at each occurrence, is independently selected from F, Cl, and H; B_{Hf} is any of F, Cl, H and OR^{Hf}_{B}, wherein R^{Hf}_{B} is a branched or straight chain alkyl radical which can be partially, substantially or completely fluorinated or chlorinated; each of W^{Hf} equal to or different from each other and at each occurrence, is independently a covalent bond or an oxygen atom; E_{Hf} is a divalent group having 2 to 10 carbon atom, optionally fluorinated; R_{Hf} is a branched or straight chain alkyl radical, which can be partially, substantially or completely fluorinated; and R_{Hf} is a halogen atom selected from the group consisting of Iodine and Bromine; which may be inserted with ether linkages; preferably E is a —(CF₂)ₘ— group, with m being an integer from 3 to 5;

### (CSM-2) Ethylenically Unsaturated Compounds Comprising Cyanide Groups, Possibly Fluorinated.

Among cure-site containing monomers of type (CSM1), preferred monomers are those selected from the group consisting of:

### (CSM1-A) Iodine-Containing Perfluorovinylethers of Formula:

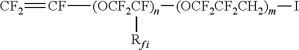

with m being an integer from 0 to 5 and n being an integer from 0 to 3, with the provisio that at least one of m and n is different from 0, and R_{fi} being F or CF₃; (as notably described in U.S. Pat. No. 4,745,165 (AUSIMONT SPA) 17 May 1988, U.S. Pat. No. 4,564,662 (MINNESOTA MINING & MFG [US]) 14 Jan. 1986 and EP 199138 A (DAIKIN IND LTD) 29 Oct. 1986); and

### (CSM-1B) Iodine-Containing Ethylenically Unsaturated Compounds of Formula:

CX¹X²═CX³—(CF₂CF₂)ₚ—I

wherein each of X¹, X² and X³, equal to or different from each other, are independently H or F; and p is an integer from 1 to 5; among these compounds, mention can be made of CH₂═CHCF₂CF₂I, I(CF₂CF₂)₂CH═CH₂, ICF₂CF₂CF═CH₂, I(CF₂CF₂)₂CF═CH₂;

### (CSM-1C) Iodine-Containing Ethylenically Unsaturated Compounds of Formula:

CHR═CH—Z—CH₂CHR—I

wherein R is H or CH₃, Z is a C₁-C₁₈ (per)fluoroalkylene radical, linear or branched, optionally containing one or more ether oxygen atoms, or a (per)fluoropolyoxyalkylene radical; among these compounds, mention can be made of CH₂═CH—(CF₂)₄CH₂CH₂I, CH₂═CH—(CF₂)₆CH₂CH₂I, CH₂ ═CH—(CF₂)₈CH₂CH₂I, CH₂═CH—(CF₂)₂CH₂CH₂I;
(CSM-1D) bromo and/or iodo alpha-olefins containing from 2 to 10 carbon atoms such as bromotrifluoroethylene or bromotetrafluorobutene described, for example, in U.S. Pat. No. 4,035,565 (DU PONT) 12 Jul. 1977 or other compounds bromo and/or iodo alpha-olefins disclosed in U.S. Pat. No. 4,694,045 (DU PONT) 15 Sep. 1987.

Among cure-site containing monomers of type (CSM2), preferred monomers are those selected from the group consisting of:

(CSM2-A) perfluorovinyl ethers containing cyanide groups of formula CF₂ ═CF—(OCF₂CFX^{CN})ₘ—O—(CF₂)ₙ—CN, with X^{CN} being F or CF₃, m being 0, 1, 2, 3 or 4; n being an integer from 1 to 12;
(CSM2-B) perfluorovinyl ethers containing cyanide groups of formula CF₂═CF—(OCF₂CFX^{CN})_{m′}—O—CF₂CF(CF₃)—CN, with X^{CN} being F or CF₃, m′ being 0, 1, 2, 3 or 4.
Specific examples of cure-site containing monomers of type CSM2-A and CSM2-B suitable to the purposes of the present invention are notably those described in U.S. Pat. No. 4,281,092 (DU PONT) 28 Jul. 1981, U.S. Pat. No. 4,281,092 (DU PONT) 28 Jul. 1981, U.S. Pat. No. 5,447,993 (DU PONT) 5 Sep. 1995 and U.S. Pat. No. 5,789,489 (DU PONT) 4 Aug. 1998.

Preferably, fluoroelastomer (A) of the invention comprises iodine or bromine cure sites in an amount of 0.001 to 10% wt. Among these, iodine cure sites are those selected for maximizing curing rate, so that fluoroelastomers (A) comprising iodine cure-sites are preferred.

According to this embodiment, for ensuring acceptable reactivity it is generally understood that the content of iodine and/or bromine in the fluoroelastomer (A) should be of at least 0.05% wt, preferably of at least 0.1% weight, more preferably of at least 0.15% weight, with respect to the total weight of fluoroelastomer (A).

On the other side, amounts of iodine and/or bromine not exceeding preferably 7% wt, more specifically not exceeding 5% wt, or even not exceeding 4% wt, with respect to the total weight of fluoroelastomer (A), are those generally selected for avoiding side reactions and/or detrimental effects on thermal stability.

These iodine or bromine cure sites of these preferred embodiments of the invention might be comprised as pending groups bound to the backbone of the fluoroelastomer (A) polymer chain (by means of incorporation in the fluoroelastomer (A) chain of recurring units derived from monomers of (CSM-1) type, as above described, and preferably of monomers of (CSM-1A) to (CSM1-D), as above detailed) or might be comprised as terminal groups of said polymer chain.

According to a first embodiment, the iodine and/or bromine cure sites are comprised as pending groups bound to the backbone of the fluoroelastomer polymer chain. The fluoroelastomer according to this embodiment generally comprises recurring units derived from iodine or bromine containing monomers (CSM-1) in amounts of 0.05 to 5 mol per 100 mol of all other recurring units of the fluoroelastomer (A), so as to advantageously ensure above mentioned iodine and/or bromine weight content.

According to a second preferred embodiment, the iodine and/or bromine cure sites are comprised as terminal groups of the fluoroelastomer (A) polymer chain; the fluoroelastomer according to this embodiment is generally obtained by addition to the polymerization medium during fluoroelastomer manufacture of anyone of:
iodinated and/or brominated chain-transfer agent(s); suitable chain-chain transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≦x+y≦2 (see, for example, U.S. Pat. No. 4,243,770 (DAIKIN IND LTD) 6 Jan. 1981 and U.S. Pat. No. 4,943,622 (NIPPON MEKTRON KK) 24 Jul. 1990); and
alkali metal or alkaline-earth metal iodides and/or bromides, such as described notably in U.S. Pat. No. 5,173,553 (AUSIMONT SRL) 22 Dec. 1992.

The fluoroelastomer composition of the invention additionally comprises at least one peroxide, typically an organic peroxide.

Among most commonly used peroxides, mention can be made of dialkyl peroxides, for instance di-tert-butyl peroxide, 2,5-dimethyl-2,5-bis(tert-butylperoxy)hexane, bis(1,1-diethylpropyl)peroxide, bis(1-ethyl-1-methylpropyl)peroxide, 1,1-diethylpropyl-1-ethyl-1-methylpropyl-peroxide, 2,5-dimethyl-2,5-bis(tert-amylperoxy)hexane; dicumyl peroxide; dibenzoyl peroxide; di-tert-butyl perbenzoate; bis[1,3-dimethyl-3-(tert-butylperoxy)butyl]carbonate.

The amount of peroxide ranges from 0.1 to 10 weight parts per 100 parts by weight of fluoroelastomer (A).

For achieving reasonable curing rates, it is generally preferred to have in the composition amounts of peroxide of at least 0.5, preferably at least 1 weight parts per 100 parts by weight of fluoroelastomer (A).

Equally, to the sake of efficiency, amount of peroxide is of generally less than 8, more preferably less than 6, still more preferably less than 5 weight parts per 100 parts by weight of fluoroelastomer (A).

The amount of meta-divinylbenzene ranges from 0.1 to 15 weight parts per 100 parts by weight of fluoroelastomer (A).

For enabling obtaining sufficient cross-linking, it is generally preferred to have in the composition amounts of meta-divinylbenzene of at least 0.5, preferably at least 1 weight parts per 100 parts by weight of fluoroelastomer (A).

Still, useful amounts of meta-divinylbenzene are of generally less than 8, more preferably less than 6, still more preferably less than 5 weight parts per 100 parts by weight of fluoroelastomer (A).

While the composition of the invention might additionally comprise other poly-unsaturated compounds, it is nevertheless generally understood that meta-divinylbenzene is preferably used as unique cross-linking agent.

Meta-divinylbenzene is generally available at a degree of purity of at least 75% wt, preferably 80% wt, and generally contains minor amounts of its para-isomer and/or of ethyl-vinyl-benzenes isomers and/or diethylbenzenes isomers and/or naphthalene.

The fluoroelastomer composition of the invention may additionally comprise other ingredients, such as notably:

(a) a metal compound, generally in amounts of between 1 and 15, and preferably between 2 and 10 weight parts per 100 parts of fluoroelastomer (A), typically selected from the group consisting of (i) oxides and hydroxides of divalent metals, for instance Mg, Zn, Ca or Pb, (ii) salts of a weak acid, for instance Ba, Na, K, Pb, Ca stearates, benzoates, carbonates, oxalates or phosphites, and (iii) mixtures of (i) and (ii);
(b) an acid acceptor of non-metal oxide/hydroxide type, selected from the group consisting of 1,8-bis(dimethylamino)naphthalene, octadecylamine, oxiranes, glycidyl resins obtained by condensation of bisphenol A and epichlorhydrine, organosilances (such as 3-glycidoxypropyl trimethoxy silane);
(c) conventional additives, selected generally from the group consisting of fillers (e.g. carbon black), thickeners, pigments, antioxidants, stabilizers, processing aids, and the like, in amounts of generally 5 and 150, preferably between 10 and 100 weight parts, more preferably between 20 and 60 weight parts, per 100 parts of fluoroelastomer (A).

It is generally understood that the fluoroelastomer composition of the invention comprises no other ingredients beside those above listed; in other terms, the inventive composition generally consists essentially of the fluoroelastomer (A), the peroxide, the meta-divinylbenzene, and optionally metal compounds, acid acceptors and conventional additives, as above detailed.

The invention also pertains to a method of using the fluoroelastomer composition, as above described, for fabricating shaped articles.

The fluoroelastomer composition can be fabricated, e.g. by moulding (injection moulding, extrusion moulding), calendering, or extrusion, into the desired shaped article, which is advantageously subjected to vulcanization (curing) during the processing itself and/or in a subsequent step (post-treatment or post-cure), advantageously transforming the relatively soft, weak, fluoroelastomer (A) into a finished article made of non-tacky, strong, insoluble, chemically and thermally resistant cured fluoroelastomer.

Finally, the invention pertains to cured articles obtained from the fluoroelastomer composition, as above detailed.

The cured articles can be notably pipes, joints, O-ring, hose, and the like.

Should the disclosure of any of the patents, patent applications, and publications that are incorporated herein by reference conflict with the present description to the extent that it might render a term unclear, the present description shall take precedence.

The present invention will be now described in more detail with reference to the following examples, whose purpose is merely illustrative and not limitative of the scope of the invention.

Mechanical and Chemical Resistance Property Determination on Cured Samples

Fluoroelastomers were compounded with the additives as detailed in following table in a Brabender mixer. Mooney viscosity (ML) (1+10@121° C.) was determined according to ASTM D1646 for curable compound. Plaques and O-rings (size class=214) have been cured in a pressed mould and then post-treated in an air circulating oven in conditions (time, temperature) below specified.

The tensile properties have been determined on specimens punched out from the plaques, according to the DIN 53504 S2 Standard.
The Shore A hardness (3″) (HDS) has been determined on 3 pieces of plaque piled according to the ASTM D 2240 method.
The compression set (C-SET) has been determined on O-ring, spaceman standard AS568A (type 214) or on 6 mm buttons (type 2), according to the ASTM D 395, method B.
Cure behaviour was characterized by Moving Disk Rheometer (MDR), at a temperature of 170° C., by determining the following properties:
M_{L}=Minimum torque (lb×in)
M_{H}=Maximum torque (lb×in)
t_{S2}=Scorch time, time for two units rise from M_{L} (sec);
t′₅₀=Time to 50% state of cure (sec)
t′₉₀=Time to 90% state of cure (sec).

Results are summarized in the following tables.

TABLE 1

| Run | |
|---|---|
| 1C | 2 |

Elastomer

| | | | |
|---|---|---|---|
| P 757(+) | phr | 100 | 100 |

Other ingredients

| | | | |
|---|---|---|---|
| paraDVB(*) | phr | 5.0 | — |
| metaDVB(**) | phr | — | 5.0 |
| Peroxide(***) | phr | 2.6 | 2.6 |
| ZnO(*v) | phr | 5.0 | 5.0 |
| Carbon black (v) | phr | 30.0 | 30.0 |

Mooney Viscosity (ML 1 + 10 min at 110° C.)

| | | | |
|---|---|---|---|
| Compound | MU | 44.0 | 51.0 |

MDR at 160° C.

| | | | |
|---|---|---|---|
| M_{L} | lb × in | 0.9 | 0.9 |
| M_{H} | lb × in | 11.8 | 11.4 |
| t_{S2} | s | 56 | 61 |
| t′₅₀ | s | 172 | 175 |
| t′₉₀ | s | 501 | 512 |

Molding: 30 min at 170° C. - No post-cure
Mechanical Properties at room temperature (23° C.)

| | | | |
|---|---|---|---|
| Tensile Strength | MPa | 9.1 | 8.9 |
| 50% Modulus | MPa | 1.4 | 1.3 |
| 100% Modulus | MPa | 1.7 | 1.6 |
| Elongation @ Break | % | 650 | 688 |
| Hardness (Shore A) | pts | 67 | 64 |

Sealing properties

| | | | | | |
|---|---|---|---|---|---|
| C-set 70 h at 200° C. | % | 29.5 | 25.7 | 28.7 | 26.9 |

(+)TECNOFLON ® P757 peroxide curable VDF-TFE-HFP terpolymer having iodine cure sites, commercially available from Solvay Specialty Polymers Italy SpA.
(*)para-divinylbenzene, commercially available from Sigma Aldrich;
(**)meta-divinylbenzene, commercially available from Sigma Aldrich;
(***)LUPEROX ® 101 XI 45 from Atofina, ~45% 2,5-dimethyl-2,5-di(t-butylperoxy)hexane (C₁₆H₃₄O₄) on calcium carbonate/silica;
(*v)from Carlo Erba;
(v) Reinforcing filler Carbon black N990MT from Cancarb.

As demonstrated by data collected in Table 1 above, the curable compounds comprising meta-divinylbenzene crosslinking agent, which is more stable and more easily available than its para-isomer, provide for substantially identical curing behaviour as compounds containing corresponding para-isomer, while delivering substantially similar properties, and even better elongation at break performances.

It is noticeable mentioning that 1,3-diisopropenylbenzene of formula:

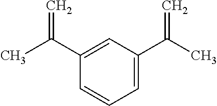

tested in strictly similar condition, did not provide any vulcanization, thus confirming behaviour, as above detailed, being specific to the presence of meta-divinylbenzene.

1. A fluoroelastomer composition comprising:
at least one fluoroelastomer (A);
from 0.1 to 15 weight parts, per 100 parts by weight of said fluoroelastomer (A), of meta-divinylbenzene; and
from 0.1 to 10 weight parts, per 100 parts by weight of said fluoroelastomer (A), of at least one peroxide.

2. The fluoroelastomer composition of claim 1, wherein fluoroelastomer (A) is selected from the group consisting of
(1) VDF-based copolymers, in which VDF is copolymerized with at least one comonomer selected from the group consisting of the followings classes:
(a) C2-C8 perfluoroolefins;
(b) hydrogen-containing C2-C8 fluoro-olefins or perfluoroalkyl ethylenes of formula CH₂═CH—R_{f}, wherein R_{f} is a C1 C6 perfluoroalkyl group;
(c) C2-C8 chloro and/or bromo and/or iodo-fluoroolefins;
(d) (per)fluoroalkylvinylethers (PAVE) of formula CF₂═CFOR_{f}, wherein R_{f} is a C1-C6 (per)fluoroalkyl group;
(e) (per)fluoro-oxy-alkylvinylethers of formula CF2=CFOX, wherein X is a C1-C12 ((per)fluoro)-oxyalkyl comprising catenary oxygen atoms;
(f) (per)fluorodioxoles having formula: 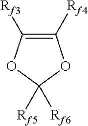
wherein R_{f3}, R_{f4}, R_{f5}, R_{f6}, equal or different from each other, are independently selected among fluorine atoms and C1-C6 (per)fluoroalkyl groups, optionally comprising one or more than one oxygen atom;
(g) (per)fluoro-methoxy-vinylethers (MOVE, hereinafter) having formula:
CFX₂═CX₂OCF₂OR″_{f}
wherein R″_{f} is selected among C1-C6 (per)fluoroalkyls, linear or branched; C5-C6 cyclic (per)fluoroalkyls; and C2-C6 (per)fluorooxyalkyls, linear or branched, comprising from 1 to 3 catenary oxygen atoms, and X₂ is selected from F and H;
(h) C2-C8 non-fluorinated olefins (Ol); and
(2) TFE-based copolymers, in which TFE is copolymerized with at least one comonomer selected from the group consisting of classes (a) (different from TFE), (c), (d), (e), (f), (g), as above detailed and the following:
(i) perfluorovinyl ethers containing cyanide groups.

3. The fluoroelastomer composition of claim 1, wherein fluoroelastomer (A) comprises recurring units derived from at least one bis-olefin (OF) having general formula: 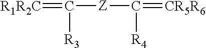
wherein R₁, R₂, R₃, R₄, R₅ and R₆, equal or different from each other, are H, a halogen, or a C1-C5 optionally halogenated group, optionally comprising one or more oxygen group; Z is a linear or branched C1-C18 optionally halogenated alkylene or cycloalkylene radical, optionally containing oxygen atoms, or a (per)fluoropolyoxyalkylene radical.

4. The fluoroelastomer composition of claim 1, wherein fluoroelastomer (A) is selected from the group consisting of fluoroelastomers having the following compositions (in mol %):
(i) vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%;
(ii) vinylidene fluoride (VDF) 50-80%, perfluoroalkyl vinyl ethers (PAVE) 5 50%, tetrafluoroethylene (TFE) 0-20%, bis-olefin (OF) 0-5%;
(iii) vinylidene fluoride (VDF) 20-30%, C2-C8 non-fluorinated olefins (Ol) 10 30%, hexafluoropropene (HFP) and/or perfluoroalkyl vinyl ethers (PAVE) 18-27%, tetrafluoroethylene (TFE) 10-30%, bis-olefin (OF) 0-5%;
(iv) tetrafluoroethylene (TFE) 50-80%, perfluoroalkyl vinyl ethers (PAVE) 20 50%, bis-olefin (OF) 0-5%;
(v) tetrafluoroethylene (TFE) 45-65%, C2-C8 non-fluorinated olefins (Ol) 20 55%, vinylidene fluoride 0-30%, bis-olefin (OF) 0-5%;
(vi) tetrafluoroethylene (TFE) 32-60% mol %, C2-C8 non-fluorinated olefins (Ol) 10-40%, perfluoroalkyl vinyl ethers (PAVE) 20-40%, fluorovinyl ethers (MOVE) 0-30%, bis-olefin (OF) 0-5%;
(vii) tetrafluoroethylene (TFE) 33-75%, perfluoroalkyl vinyl ethers (PAVE) 15 45%, vinylidene fluoride (VDF) 5-30%, hexafluoropropene HFP 0-30%, bis-olefin (OF) 0-5%;
(viii) vinylidene fluoride (VDF) 35-85%, fluorovinyl ethers (MOVE) 5-40%, perfluoroalkyl vinyl ethers (PAVE) 0-30%, tetrafluoroethylene (TFE) 0-40%, hexafluoropropene (HFP) 0-30%, bis-olefin (OF) 0-5%; and
(ix) tetrafluoroethylene (TFE) 20-70%, fluorovinyl ethers (MOVE) 30-80%, perfluoroalkyl vinyl ethers (PAVE) 0-50%, bis-olefin (OF) 0-5%.

5. The fluoroelastomer composition of claim 1, wherein fluoroelastomer (A) comprises cure sites.

6. The fluoroelastomer composition of claim 5, wherein fluoroelastomer (A) comprises said cure sites as pendant groups bonded to certain recurring units, selected from the group consisting of:
(CSM-1) iodine or bromine containing monomers of formula: 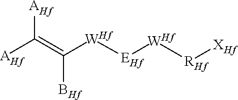
wherein
each of A_{Hf}, equal to or different from each other and at each occurrence, is independently selected from F, Cl, and H; B_{Hf} is any of F, Cl, H and OR^{Hf}_{B}, wherein R^{Hf}_{B} is a branched or straight chain alkyl radical which can be partially, substantially or completely fluorinated or chlorinated; each of W_{Hf} equal to or different from each other and at each occurrence, is independently a covalent bond or an oxygen atom; E_{Hf} is a divalent group having 2 to 10 carbon atom, optionally fluorinated; R_{Hf} is a branched or straight chain alkyl radical, which can be partially, substantially or completely fluorinated; and X_{Hf} is a halogen atom selected from the group consisting of Iodine and Bromine; which may be inserted with ether linkages; and
(CSM-2) ethylenically unsaturated compounds comprising cyanide groups, possibly fluorinated.

7. The fluoroelastomer composition of claim 5, wherein fluoroelastomer (A) comprises said cure sites as end groups of the polymer chain.

8. The fluoroelastomer composition of claim 1, wherein said peroxide is an organic peroxide selected from the group consisting of dialkyl peroxide; dicumyl peroxide; dibenzoyl peroxide; di-tert-butyl perbenzoate; and bis[1,3-dimethyl-3-(tert-butylperoxy)butyl]carbonate.

9. The fluoroelastomer composition of claim 1, said composition comprising meta-divinylbenzene in an amount of at least 0.5 weight parts per 100 parts by weight of fluoroelastomer (A), and of less than 8 weight parts per 100 parts by weight of fluoroelastomer (A).

10. The fluoroelastomer composition of claim 1, said composition additionally comprising other poly-unsaturated compounds.

11. The fluoroelastomer composition of claim 1, wherein meta-divinylbenzene is present at a degree of purity of at least 75% wt and wherein meta-divinylbenzene contains minor amounts of its para-isomer and/or of ethyl-vinyl-benzenes isomers and/or diethylbenzenes isomers and/or naphthalene.

12. The fluoroelastomer composition of claim 1, said composition additionally comprising at least one other ingredient selected from the group consisting of:
(a) a metal compound in amounts of between 1 and 15 weight parts per 100 parts of fluoroelastomer (A), selected from the group consisting of (i) oxides and hydroxides of divalent metals, (ii) salts of a weak acid, and (iii) mixtures of (i) and (ii);
(b) an acid acceptor of non-metal oxide/hydroxide type, selected from the group consisting of 1,8 bis(dimethylamino)naphthalene, octadecylamine, oxiranes, glycidyl resins obtained by condensation of bisphenol A and epichlorhydrine, organosilanes (such as 3-glycidoxypropyl trimethoxy silane);
(c) conventional additives, selected from the group consisting of fillers, thickeners, pigments, antioxidants, stabilizers, and processing aids, in amounts of between 5 and 150 weight parts, per 100 parts of fluoroelastomer (A).

13. A method of fabricating a shaped article, the method comprising moulding, calendering, or extruding the fluoroelastomer composition according to claim 1, such that a shaped article is fabricated.

14. The method according to claim 13, wherein the method further comprises vulcanizing the shaped article during the processing itself and/or in a subsequent step.

15. A cured article obtained from the fluoroelastomer composition according to claim 1.

16. The fluoroelastomer composition of claim 2, wherein fluoroelastomer (A) is selected from the group consisting of:
(1) VDF-based copolymers, in which VDF is copolymerized with at least one comonomer selected from the group consisting of tetrafluoroethylene (TFE); hexafluoropropylene (HFP); vinyl fluoride (VF); trifluoroethylene (TrFE); chlorotrifluoroethylene (CTFE); (per)fluoroalkylvinylethers (PAVE) of formula CF₂═CFOR_{f}, wherein R_{f} is selected from CF₃, C₂F₅, and C₃F₇; (per)fluoro-oxy-alkylvinylethers of formula CF₂═CFOX, wherein X is perfluoro-2-propoxypropyl; (per)fluorodioxoles having formula: 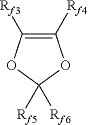
wherein R_{f3}, R_{f4}, R_{f5}, R_{f6}, equal or different from each other, are independently selected from —CF₃, —C₂F₅, —C₃F₇, —OCF₃, and —OCF₂CF₂OCF₃; (per)fluoro-methoxy-vinylethers (MOVE) having formula:
CFX₂═CX₂OCF₂OR″_{f}
wherein R″_{f} is selected from —CF₂CF₃, —CF₂CF₂OCF₃, and —CF₃ and X₂ is F; ethylene; and propylene; and
(2) TFE-based copolymers, in which TFE is copolymerized with at least one comonomer selected from the group consisting of tetrafluoroethylene (TFE); hexafluoropropylene (HFP); vinyl fluoride (VF); trifluoroethylene (TrFE); chlorotrifluoroethylene (CTFE); (per)fluoroalkylvinylethers (PAVE) of formula CF₂═CFOR_{f}, wherein R_{f} is selected from CF₃, C₂F₅, and C₃F₇; (per)fluoro-oxy-alkylvinylethers of formula CF₂═CFOX, wherein X is perfluoro-2-propoxypropyl; (per)fluorodioxoles having formula: 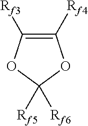
wherein R_{f3}, R_{f4}, R_{f5}, R_{f6}, equal or different from each other, are independently selected from —CF₃, —C₂F₅, —C₃F₇, —OCF₃, and —OCF₂CF₂OCF₃; (per)fluoro-methoxy-vinylethers (MOVE) having formula:
CFX₂═CX₂OCF₂OR″_{f}
wherein R″_{f} is selected from —CF₂CF₃, —CF₂CF₂OCF₃, and —CF₃ and X₂ is F; ethylene;
and propylene.

17. The fluoroelastomer composition of claim 6, wherein E is a (CF₂)ₘ— group wherein m is an integer from 3 to 5.

18. The fluoroelastomer composition of claim 8, wherein the dialkyl peroxide is selected from the group consisting of di-tert-butyl peroxide, 2,5-dimethyl-2,5-bis(tert-butylperoxy)hexane, bis(1,1-diethylpropyl)peroxide, bis(1-ethyl-1-methylpropyl)peroxide, 1,1-diethylpropyl-1-ethyl-1-methylpropyl-peroxide, and 2,5-dimethyl-2,5-bis(tert-amylperoxy)hexane.

19. The fluoroelastomer composition of claim 9, said composition comprising meta-divinylbenzene in an amount of at least 1 weight part per 100 parts by weight of fluoroelastomer (A), and of less than 5 weight parts per 100 parts by weight of fluoroelastomer (A).

20. The fluoroelastomer composition of claim 11, wherein meta-divinylbenzene is present at a degree of purity of at least 80% wt, and wherein meta-divinylbenzene contains minor amounts of its para-isomer and/or of ethyl-vinyl-benzenes isomers and/or diethylbenzenes isomers and/or naphthalene.
